(19) United States
(12) Patent Application Publication
(10) Pub. No.: US 2026/0237733 A1
(43) Pub. Date: Aug. 13, 2026

(54) SULFIDE-BASED SOLID ELECTROLYTE AND ALL-SOLID-STATE BATTERY COMPRISING SAME

(71) Applicant: LG ENERGY SOLUTION, LTD., Seoul (KR)

(72) Inventors: Sunggeun SHIM, Daejon (KR); Youngbok KIM, Daejon (KR); Wonrak LEE, Daejon (KR)

(21) Appl. No.: 19/156,724

(22) PCT Filed: Jan. 16, 2025
(86) PCT No.: PCT/KR2025/099014

§ 371 Date: Aug. 14, 2025

(30) Foreign Application Priority Data
Jan. 30, 2024 (KR) 10-2024-0013764

(51) Int. Cl. H01M 10/0562; H01M 4/02; H01M 4/38

(52) U.S. Cl. CPC H01M 10/0562; H01M 4/382; H01M 2004/027; H01M 2300/0068

(57) ABSTRACT

A sulfide-based solid electrolyte and an all-solid-state battery including the same. The sulfide-based solid electrolyte includes lithium (Li), phosphorus (P), sulfur (S), and chlorine (Cl), wherein a heterogeneous element is substituted at the phosphorus (P) site, and if at least two selected from the group consisting of Ge, Sn, Sb and Si are substituted in equal proportions, the ionic conductivity of the sulfide-based solid electrolyte can be improved.

### CROSS-CITATION TO RELATED APPLICATIONS

This application is a National Stage Application of International Application No. PCT/KR2025/099014 filed on Jan. 16, 2025, which claims the benefit of priority to Korean Patent Application No. 10-2024-0013764, filed Jan. 30, 2024, the disclosures of which are incorporated herein by reference in their entirety.

### TECHNICAL FIELD

The present disclosure relates to a sulfide-based solid electrolyte and an all-solid-state battery comprising same.

### RELATED ART

A variety of batteries are being researched to overcome the limitations of the current lithium secondary batteries in terms of capacity, safety, output, large-scale applications, and microminiaturization.

Representative examples include metal-air batteries, which have a very high theoretical capacity compared to lithium secondary batteries; all-solid-state batteries, which have no risk of explosion and are safe; supercapacitors in terms of output; NaS batteries or redox flow batteries (RFB) for large-scale applications; and thin film batteries for microminiaturization. Continuous research is being conducted in academia and industry on these technologies.

An all-solid-state battery is a battery in which the liquid electrolyte used in a conventional lithium secondary battery is replaced with a solid electrolyte, and since no flammable solvent is used in the battery, there is no possibility of ignition or explosion due to the decomposition reaction of the conventional electrolyte, which greatly improves safety. It also has the advantage of being able to use lithum metal or lithium alloys as negative electrode materials, which can dramatically improve the energy density relative to the mass and volume of the battery.

However, in an all-solid-state battery, the solid electrolyte is applied in a small particle size, which can lead to more interfaces and increased resistance, which in turn can degrade the performance, lifetime, and stability of the all-solid-state battery, resulting in poor battery performance.

The degradation of battery performance due to this increase in interfacial resistance can be offset by increasing the ionic conductivity of the solid electrolyte.

Therefore, it is necessary to develop a solid electrolyte with high ionic conductivity as a solid electrolyte for an all-solid-state battery.

### Prior Art Reference

### Patent Reference

(Patent Reference 1) Japanese Laid-open Patent Publication No. 2015-22015

### BRIEF DESCRIPTION

The inventors of the present disclosure have conducted various studies to solve the above problems and have found that in a sulfide-based solid electrolyte comprising lithium (Li), phosphorus (P), sulfur (S), and chlorine (CI), the ionic conductivity of the sulfide-based solid electrolyte is improved when two or more elements selected from the group consisting of Ge, Sn, Sb and Si are used as a substitute for a part of the P site.

Accordingly, it is an object of the present disclosure to provide a sulfide-based solid electrolyte with improved ionic conductivity.

It is another object of the present disclosure to provide an all-solid-state battery comprising a sulfide-based solid electrolyte with improved ionic conductivity.

To accomplish the above objectives, the present disclosure provides a sulfide-based solid electrolyte comprising lithium (Li), phosphorus (P), sulfur (S), chlorine (CI) and M, wherein M is included as a substitute for a part of the phosphorus (P) site and comprises at least two selected from the group consisting of Ge, Sn, Sb and Si.

In one example of the present disclosure, the sulfide-based solid electrolyte is provided as represented by Formula 1 below:

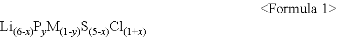

wherein x is 0<x<0.6, and y is 0<y≤0.9,
wherein M is M1ₐM2_{b} (wherein 0<a+b≤0.1, and a+b=1−y), M1ₐM2_{b}M3_{c} (wherein 0<a+b+c<0.1, and a+b+c=1−y) or M1ₐM2_{b}M3_{c}M4_{d} (wherein 0<a+b+c+d≤0.1, and a+b+c+d=1−y),
wherein M1, M2, M3, and M4 are different elements selected from the group consisting of Ge, Si, Sb and Sn, respectively.

In one example of the present disclosure, provided is a sulfide-based solid electrolyte, wherein the two or more elements that substitute for a part of the phosphorus (P) site are substituted in equal proportions, such that M is M1ₐM2_{b}(wherein 0<a+b<0.1, a+b=1−y, and a=b), M1ₐM2_{b}M3_{c} (wherein 0<a+b+c s 0.1, a+b+c=1−y, and a=b=c) or M1ₐM2_{b}M3_{c}M4_{d} (wherein 0<a+b+c+d<0.1, a+b+c+d=1−y, and a=b=c=d).

In one example of the present disclosure, provided is a sulfide-based solid electrolyte, which has an argyrodite-type crystal structure.

In one example of the present disclosure, provided is a sulfide-based solid electrolyte with an ionic conductivity of 4 to 6 mS/cm.

In one example of the present disclosure, provided is a sulfide-based solid electrolyte, wherein the impurity content in the sulfide-based solid electrolyte is 0% to 5% based on the intensity of the XRD main peak.

In one example of the present disclosure, provided is a sulfide-based solid electrolyte, wherein the impurity comprises Li₂S, LiCl, or a compound thereof.

The present disclosure also provides an all-solid-state battery comprising a positive electrode, a negative electrode, and the sulfide-based solid electrolyte interposed therebetween.

In one example of the present disclosure, provided is an all-solid-state battery, wherein the negative electrode may be a lithium negative electrode comprising a lithium metal.

### Advantageous Effects

According to the solid electrolyte according to the present disclosure, by substituting two or more elements selected from the group consisting of Ge, Sn, Sb and Si for a part of the phosphorus (P) site included in the sulfide-based solid electrolyte, the increase of solid solubility of the substituent is improved, thereby improving the ionic conductivity of the sulfide-based solid electrolyte and reducing impurities.

### DETAILED DESCRIPTION

Hereinafter, the present disclosure will be described in more detail to provide a better understanding.

The terms and words used in this specification and claims are not to be construed in their ordinary or dictionary sense, but rather in a sense and concept consistent with the technical idea of the present disclosure, based on the principle that the inventor may define the concept of a term as he/her sees fit to best describe his/her invention.

### Sulfide-Based Solid Electrolyte

The present disclosure relates to a sulfide-based solid electrolyte.

The sulfide-based solid electrolyte according to the present disclosure comprises lithium (Li), phosphorus (P), sulfur (S), chlorine (CI) and M, wherein M is included as a substitute for a part of the phosphorus (P) site and comprises at least two selected from the group consisting of Ge, Sn, Sb and Si.

When two or more elements selected from the group consisting of Ge, Sn, Sb and Si are substituted at the P site, the ionic conductivity of the sulfide-based solid electrolyte can be improved by increasing the disorder in the structure, allowing lithium ions to move smoothly. Preferably, the two or more elements may be substituted in equal proportions.

If a single element is used as a substitute at the P site, the amount of the substituted element may exceed the permissible substitution level within the structure of the sulfide-based solid electrolyte, leading to its precipitation as an impurity. In this case, the ionic conductivity of the sulfide-based solid electrolyte can be improved by reducing the substitution ratio of the single element and adding elements of heterogeneous types together to increase the substitution ratio. For example, if two heterogeneous elements, Sn and Si, are substituted in equal proportions, resulting in P_{0.94}Sn_{0.03}Si_{0.03}, compared to the case that only single element, Sn, is substituted at the P site, resulting in P_{0.94}Sn_{0.06}, the ionic conductivity can be improved by increasing the disorder in the structure.

In one example of the present disclosure, the sulfide-based solid electrolyte may be that represented by Formula 1 below:

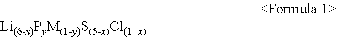

wherein x is 0<x<0.6, and y is 0<y≤0.9,
wherein M is M1ₐM2_{b} (wherein 0<a+b<0.1, and a+b=1−y), M1ₐM2_{b}M3_{c} (wherein 0<a+b+c<0.1, and a+b+c=1−y) or M1ₐM2_{b}M3_{c}M4_{d} (wherein 0<a+b+c+d≤0.1, and a+b+c+d=1−y),
wherein M1, M2, M3, and M4 are different elements selected from the group consisting of Ge, Si, Sb and Sn, respectively.

For example, the sulfide-based solid electrolyte represented by Formula 1 above may be Li_{5.5}P_{0.94}Si_{0.03}Sn_{0.03}S_{4.5}Cl_{1.5}.

Furthermore, the two or more elements used as a substitute at the P site may be substituted in equal proportions. If the ratio of two or more substituted elements is not equal, impurities may occur or the ionic conductivity may decrease. For example, in Formula 1 above, M may be M1ₐM2_{b}(wherein 0<a+b<0.1, a+b=1−y, and a=b), M1ₐM2_{b}M3_{c} (wherein 0<a+b+c s 0.1, a+b+c=1−y, and a=b=c) or M1ₐM2_{b}M3_{c}M4_{d} (wherein 0<a+b+c+d<0.1, a+b+c+d=1−y, and a=b=c=d).

In one example of the present disclosure, the sulfide-based solid electrolyte may have an argyrodite-type crystal structure. The argyrodite-type crystal structure is the structure obtained by replacing a part of the substance with chlorine.

The crystal structure of the sulfide-based solid electrolyte is originally a face-centered cubic lattice (FCC) structure, which means that lithium ions are trapped in the sulfur atom octahedron during their movement. However, replacing a part of the substance with chlorine can change the strength of the electrostatic attraction, altering the arrangement of atoms within the structure, which in turn lowers the activation energy and provides a new pathway for lithium ion migration, thus improving ionic conductivity. In addition to this argyrodite-type crystal structure, the present disclosure provides a structure in which two or more elements are used as a substitute at the P site, which reduces the amount of impurities and further improves the ionic conductivity.

In one example of the present disclosure, the ionic conductivity of the sulfide-based solid electrolyte may be 4 to 6 mS/cm.

The sulfide-based solid electrolyte may have two or more elements used as a substitute at the P site, resulting in a disorder having a crystal structure. This can facilitate the movement of lithium ions, and the ionic conductivity can be improved by increasing the ratio of solid solubility of the elements, which can also reduce impurities.

In one example of the present disclosure, the amount of impurity in the sulfide-based solid electrolyte may be 0% to 5% based on the intensity of the XRD main peak, and the impurities may include Li₂S, LiCl, or a compound thereof. The impurities may be result from the raw materials of the sulfide-based solid electrolyte failing to be dissolved into the structure and precipitating as impurities, or the formation of new types of impurities among themselves.

### Method of Preparing Sulfide-Based Solid Electrolyte

The present disclosure also relates to a method of preparing a sulfide-based solid electrolyte.

A method of preparing a sulfide-based solid electrolyte according to the present disclosure comprises: (S1) grinding raw materials; and (S2) heat treating the powder obtained in step (S1). This can also be referred to as a solid-phase synthesis.

Hereinafter, a method for preparing a sulfide-based solid electrolyte according to the present disclosure will be described in more detail by each step.

In one example of the present disclosure, in step (S1), the raw materials may be ground.

The raw materials may refer to the raw materials of each element contained in the sulfide-based solid electrolyte. The above raw materials are not particularly limited as long as they are substances commonly used in the art as raw materials for each element. For example, the raw materials may include raw materials forming a sulfide-based solid electrolyte and raw materials of elements used as a substitute at the P site. The raw materials forming the sulfide-based solid electrolyte may include lithium sulfide (Li₂S), phosphorus pentasulfide (P₂S₅), and lithium chloride (LiCl), and the raw materials of the substitute elements may include at least two selected from the group consisting of silicon (Si), silicon sulfide (SiS₂), tin sulfide (SnS₂), germanium sulfide (GeS₂), and antimony sulfide (Sb₂S₅). In addition, for each mole of lithium sulfide (Li₂S), 0.1 to 0.5 mole of phosphorus pentasulfide (P₂S₅), 0.5 to 1.5 mole of lithium chloride (LiCl), and 0.01 to 0.1 mole of raw materials of the above substitute elements may be used. Specifically, the phosphorus pentasulfide (P₂S₅) may be 0.1 mole or more, 0.15 mole or more, or 0.2 mole or more, and may be used in amounts of 0.5 mole or less, 0.4 mole or less, or 0.3 mole or less. Further, the lithium chloride (LiCl) may be 0.5 moles or more, 0.6 moles or more, or 0.7 moles or more, and may be used in amounts of 1.5 moles or less, 1.4 moles or less, 1.3 moles or less, 1.2 moles or less, 1.1 moles or less, 1.0 moles or less, 0.9 moles or less, or 0.8 moles or less. Furthermore, the raw materials of the substitute elements may be 0.01 moles or more, 0.02 moles or more, or 0.03 moles or more, and may be used in amounts of 0.1 moles or less, 0.09 moles or less, 0.08 moles or less, 0.07 moles or less, 0.06 moles or less, or 0.05 moles or less.

Further, the grinding method is not particularly limited as long as it can be practiced to obtain a powder. For example, the grinding method may be milling, which may be hand milling, ball milling, or the like.

In one example of the present disclosure, in step (S₂), the powder obtained in step (S₁) may be heat treated.

The heat treatment may be carried out under an inert atmosphere, at a temperature of 400° C. to 600° C. and under conditions of 10 hours to 14 hours. The inert atmosphere may refer to a nitrogen, helium, argon, or carbon dioxide atmosphere. The temperature may be 400° C. or more, 450° C. or more, or 500° C. or more, and may be 600° C. or less, 580° C. or less, or 560° C. or less.

Furthermore, the sulfide-based solid electrolyte according to the present disclosure can be obtained through the above steps (S1) and (S2), and the manufacturing process including the above steps (S1) and (S2) can be carried out in a glove box that is not exposed to moisture and oxygen.

### All-Solid-State Battery

The present disclosure also relates to an all-solid-state battery comprising the sulfide-based solid electrolyte.

An all-solid-state battery according to the present disclosure comprises: the sulfide-based solid electrolyte; a positive electrode formed on one side of the sulfide-based solid electrolyte; and a negative electrode formed on the other side of the sulfide-based solid electrolyte.

In one example of the present disclosure, the positive electrode may include a positive electrode active material, a conductive material, and a binder.

In the present disclosure, the positive electrode included in the all-solid-state battery includes a positive electrode active material layer, wherein the positive electrode active material layer may be formed on one side of the positive electrode current collector.

The positive electrode active material layer includes a positive electrode active material, a conductive material, and a binder.

Furthermore, the positive electrode active material may be any material capable of reversibly adsorbing and releasing lithium ions, without being particularly limited thereto, for example, a layered compound such as lithium cobalt oxide (LiCoO₂), lithium nickel oxide (LiNiO₂), Li[NiₓCo_{y}Mn_{z}Mᵥ]O₂ (wherein M is any one or two or more elements selected from the group consisting of Al, Ga and In; and 0.3≤x<1.0, 0≤y, z≤0.5, 0≤v≤0.1, and x+y+z+v=1), Li(LiₐM_{b-a-b′}M′_{b′})O_{2-c}A_{c} (wherein O≤a≤0.2, 0.6≤b≤1, 0≤b′≤0.2, and 0≤c≤0.2; M comprises at least one selected from the group consisting of Mn, Ni, Co, Fe, Cr, V, Cu, Zn, and Ti; M′ comprises at least one selected from the group consisting of Al, Mg and B; and A comprises at least one selected from the group consisting of P, F, S and N), or a compound substituted with one or more transition metals; a lithium manganese oxide such as a compound of formula Li_{1+y}Mn_{2-y}O₄ (wherein y is 0 to 0.33), LiMnO₃, LiMn₂O₃, or LiMnO₂; a lithium copper oxide (Li₂CuO₂); a vanadium oxide, such as LiV₃O₈, LiFe₃O₄, V₂O₅, or Cu₂V₂O₇; a Ni site-type lithium nickel oxide represented by formula LiNi_{1-y}MyO₂ (wherein M is Co, Mn, Al, Cu, Fe, Mg, B or Ga, and y is 0.01 to 0.3; a lithium manganese complex oxide represented by formula LiMn_{2-y} M_{y}O₂ (wherein M is Co, Ni, Fe, Cr, Zn, or Ta, and y is 0.01 to 0.1) or Li₂Mn₃MO₈ (wherein M is Fe, Co, Ni, Cu, or Zn); LiMn₂O₄, in which a portion of the Li in the formula is substituted by an alkaline earth metal ion; a disulfide compound; Fe₂(MoO₄)₃; and the like, but not limited thereto.

Further, the positive electrode active material may be included in an amount of 60 to 80% by weight based on the total weight of the positive electrode active material layer. Specifically, the amount of the positive electrode active material may be 60% by weight or more, 65% by weight or more, or 68% by weight or more, 72% by weight or less, 75% by weight or less, or 80% by weight or less. If the amount of the positive electrode active material is less than 60% by weight, the battery performance may be reduced, and if the amount is greater than 80% by weight, the mass transfer resistance may be increased.

Furthermore, the conductive material is not particularly limited as long as it prevents side reactions in the internal environment of an all-solid-state battery and has excellent electrical conductivity without causing chemical changes in the battery, and graphite or conductive carbon can be used as a representative, for example, graphite such as natural graphite, artificial graphite, and the like; carbon black such as carbon black, acetylene black, ketjen black, denka black, thermal black, channel black, furnace black, lamp black, summer black, and the like; carbon-based materials having a crystal structure of graphene or graphite; conductive fibers such as carbon fibers, metal fibers, etc.; carbon fluorides; metal powders, such as aluminum powder, nickel powder, etc.; conductive whiskeys, such as zinc oxide, potassium titanate, etc.; conductive oxides, such as titanium oxide; and conductive polymers, such as polyphenylene derivatives; can be used alone or in a mixture of two or more of the foregoing, but are not necessarily limited thereto. Preferably, the conductive material may comprise vapor-grown carbon fiber (VGCF).

Further, the conductive material may be included in an amount of 1% by weight to 5% by weight based on the total weight of the positive electrode active material layer, and more specifically, the amount of the conductive material may be 1% by weight or more, 1.5% by weight or more, 2% by weight or more, and may be 4% by weight or less, 4.5% by weight or less, or 5% by weight or less. If the amount of the conductive material is too small, such as less than 1% by weight, it is difficult to expect the effect of improving the electrical conductivity or the electrochemical properties of the battery may be degraded, and if it is too large, such as more than 5% by weight, the amount of positive electrode active material may be relatively small, resulting in a decrease in capacity and energy density. The method of incorporating the conductive material into the positive electrode is not substantially limited, and any conventional method known in the art can be used, such as mixing with or coating the positive electrode active material.

The binder is a component that assists in the bonding of the positive electrode active material and the conductive material or the bonding to a current collector, and may comprise at least one selected from the group consisting of styrene-butadiene rubber, acrylated styrene-butadiene rubber, acrylonitrile copolymer, acrylonitrile-butadiene rubber, nitrile butadiene rubber, acrylonitrile-styrene-butadiene copolymer, acrylic rubber, butyl rubber, fluorine rubber, polytetrafluoroethylene, polyethylene, polypropylene, ethylene/propylene copolymer, polybutadiene, polyethylene oxide, chlorosulfonated polyethylene, polyvinylpyrrolidone, polyvinylpyridine, polyvinyl alcohol, polyvinyl acetate, polypichlorohydrin, polyphosphazene, polyacrylonitrile, polystyrene, latex, acrylic resin, phenolic resin, epoxy resin, carboxymethylcellulose, hydroxypropyl cellulose, cellulose acetate, cellulose acetate butyrate, cellulose acetate propionate, cyanoethylcellulose, cyanoethyl sucrose, polyester, polyamide, polyether, polyimide, polycarboxylate, polycarboxylic acid, polyacrylic acid, polyacrylate, lithium polyacrylate, polymethacrylic acid, polymethacrylate, polyacrylamide, polyurethane, polyvinylidene fluoride, and poly(vinylidene fluoride)—hexafluoropropene. Preferably, the binder may comprise polytetrafluoroethylene (PTFE).

Further, the binder may be included in an amount of 0.5% by weight to 4% by weight based on the total weight of the positive electrode active material layer, and more specifically, the amount of the binder may be 0.5% by weight or more, 1% by weight or more, 1.5% by weight or more, 3% by weight or less, 3.5% by weight or less, or 4% by weight or less. If the binder amount is less than 0.5% by weight, the adhesion of the positive electrode active material to the positive electrode current collector may be reduced, and if the binder amount is greater than 4% by weight, the adhesion may be improved, but the amount of the positive electrode active material may be reduced, resulting in a lower cell capacity.

Further, the positive electrode current collector supports the positive electrode active material layer and serves to transfer electrons between the outer wire and the positive electrode active material layer.

The positive electrode current collector is not particularly limited as long as it has a high electronic conductivity without causing chemical changes in an all-solid-state battery. For example, copper, stainless steel, aluminum, nickel, titanium, palladium, calcined carbon, copper or stainless steel whose surface is treated with carbon, nickel, or silver, aluminum-cadmium alloy, and the like may be used as the positive electrode current collector.

The positive electrode current collector may have a microscopic uneven structure or adopt a three-dimensional porous structure on the surface of the positive electrode current collector to strengthen the binding force with the positive electrode active material layer. Accordingly, the positive electrode current collector may comprise various forms such as film, sheet, foil, mesh, net, porous material, foam, nonwoven material, and the like.

The positive electrode as described above can be manufactured according to conventional methods, and more specifically, by applying a composition for forming a positive electrode active material layer prepared by mixing a positive electrode active material with a conductive material and a binder in an organic solvent on the positive electrode current collector and drying same, and optionally, compression molding the same on the current collector to improve the electrode density. In this case, it is preferable to use an organic solvent that can uniformly disperse a positive electrode active material, a binder and a conductive material, and that is easily evaporated. Specifically, the examples include acetonitrile, methanol, ethanol, tetrahydrofuran, water, and isopropyl alcohol.

In the present disclosure, the negative electrode included in the all-solid-state battery comprises a negative electrode active material layer, wherein the negative electrode active material layer may be formed on one side of the negative electrode current collector.

The negative electrode active material may comprise a material capable of reversibly intercalating or deintercalating lithium (Li⁺), a material capable of reacting with lithium ions to reversibly form a lithium-containing compound, a lithium metal, or a lithium alloy.

The material into which the lithium ions (Li⁺) can be reversibly inserted or removed can be, for example, crystalline carbon, amorphous carbon, or a mixture thereof. The material capable of reacting with the lithium ions (Li⁺) to reversibly form a lithium-containing compound may be, for example, tin oxide, titanium nitrate, or silicon. The lithium alloy may be, for example, an alloy of lithium (Li) and a metal selected from the group consisting of indium (In), sodium (Na), potassium (K), rubidium (Rb), cesium (Cs), francium (Fr), beryllium (Be), magnesium (Mg), calcium (Ca), strontium (Sr), barium (Ba), radium (Ra), aluminum (AI), and tin (Sn).

Preferably, the negative electrode active material may be a lithium metal or a lithium-indium alloy (Li—In), more specifically, it may be in the form of a lithium metal or a lithium thin film or a lithium-indium alloy thin film or powder.

The negative electrode active material may be included in an amount of 40 to 80% by weight based on the total weight of the negative electrode active material layer. Specifically, the amount of the negative electrode active material may be 40% by weight or more, 50% by weight or more, or may be 70% by weight or less, or 80% by weight or less. If the amount of the negative electrode active material is less than 40% by weight, the connectivity between the wet negative electrode active material layer and the dry negative electrode active material layer may be insufficient, and if the amount is greater than 80% by weight, the mass transfer resistance may be greater.

Further, the binder is as described above for the positive electrode active material layer.

In addition, the conductive material is as described above for the positive electrode active material layer.

Furthermore, the negative electrode current collector is not particularly limited as long as it is conductive without causing chemical changes in the battery, for example, copper, stainless steel, aluminum, nickel, titanium, calcined carbon, copper or stainless steel whose surface is treated with carbon, nickel, or silver, aluminum-cadmium alloy, and the like can be used. Also, like the positive electrode current collector, the negative electrode current collector can be in various forms, such as a film, sheet, foil, net, porous material, foam, nonwoven material, etc. with fine irregularities formed on the surface.

The method of manufacturing a negative electrode is not particularly limited, and can be manufactured by forming a negative electrode active material layer on the negative electrode current collector using a conventional method of forming a layer or a film. For example, methods such as pressing, coating, or deposition can be utilized. The negative electrode of the present disclosure also includes the case in which a metallic lithium thin film is formed on a metal plate by initial charging after the battery is assembled without a lithium thin film on the negative electrode current collector.

### Battery Module

The present disclosure also relates to a battery module comprising the all-solid-state battery as a unit cell, a battery pack comprising the battery module, and a device comprising the battery pack as a power source.

Specific examples of such devices include, but are not limited to, a power tool powered by an electric motor; an electric vehicle, including an electric vehicle (EV), a hybrid electric vehicle (HEV), a plug-in hybrid electric vehicle (PHEV), and the like; an electric two-wheeled vehicle, including an electric bicycle (E-bike) and an electric scooter (E-scooter); an electric golf cart; a power storage system; and the like.

### EXAMPLES

Hereinafter, preferred examples of the present disclosure are described for the purpose of illustrating the present disclosure, but it will be apparent to those skilled in the art that various changes and modifications are possible within the scope of the present disclosure and the technical idea, and that such changes and modifications fall within the scope of the appended patent claims.

### Example 1

In the glove box, the raw materials were ground by hand milling for 30 minutes and then subjected to a solid-phase synthesis method by heat treatment at a temperature of 520° C. under an Ar atmosphere for 12 hours to prepare a sulfide-based solid electrolyte. The raw materials were 2 moles of lithium sulfide (Li₂S, Mitsuwa Chemical), 0.47 moles of phosphorus pentasulfide (P₂S5, Aldrich), 1.5 moles of lithium chloride (LiCl, Aldrich), 0.03 moles of silicon (Si, Sigma Aldrich), and 0.03 moles of tin sulfide (SnS₂, Kojundo).

### Comparative Example 1

Li₅₅PS₄₅Cl_{1.5} was prepared in the same manner as Example 1 except that no substitute elements were substituted at the P site. The raw materials were 2 moles of lithium sulfide (Li₂S, Mitsuwa Chemical), 0.5 moles of phosphorus pentasulfide (P₂S₅, Aldrich), and 1.5 moles of lithium chloride (LiCl, Aldrich).

### Comparative Example 2

Li_{5.5}P_{0.94}Sn_{0.06}S_{4.5}Cl_{1.5} was prepared in the same way as Example 1, except that only one substitute element, i.e., Sn, was substituted at the P site. The raw materials were 2 moles of lithium sulfide (Li₂S, Mitsuwa Chemical), 0.47 moles of phosphorus pentasulfide (P₂S₅, Aldrich), 1.5 moles of lithium chloride (LiCl, Aldrich), and 0.06 moles of tin sulfide (SnS₂, Kojundo).

### Experimental Example 1: Measurement of Ionic Conductivity

To measure the ionic conductivity of the sulfide-based solid electrolytes prepared in the Example and Comparative Examples, an electrochemical impedance spectroscopy (EIS) analysis was performed.

For the EIS analysis, an electrode cell was fabricated. The electrode cell was prepared using a 13 mm diameter electrode, by adding 200 mg of the sulfide-based solid electrolyte to the electrode and pressurizing it to a pressure of 360 MPa.

Using an electrochemical impedance spectrometer (EIS, VMP300Bio Logic), the ionic conductivity of the sulfide-based solid electrolyte was calculated by measuring the resistance at 25° C., AC 0.1 V and a frequency of 1 Hz to 0.1 MHz using Formula 1 below.

$${σ}_{i} = \frac{L}{RA} \qquad 〈 Formula 1 〉$$

In Formula 1, σᵢ is the ionic conductivity of the sulfide-based solid electrolyte (mS/cm), R is the resistance of the sulfide-based solid electrolyte (Ω) measured by the above electrochemical impedance spectrometer, L is the thickness of the sulfide-based solid electrolyte (μm), and A is the area of the sulfide-based solid electrolyte (cm²).

Table 1 below shows the composition and measured ionic conductivity of the sulfide-based solid electrolytes prepared in the Example and Comparative Examples. The compositions of the sulfide-based solid electrolytes listed in Table 1 below show the composition of each element in Formula 1.

TABLE 1

| | | | | | | | | Ionic |
|---|---|---|---|---|---|---|---|---|
| | | | | | | | | conductivity |
| | Li | P | Sn | Sb | Si | S | Cl | (mS/cm) |
| Example 1 | 5.5 | 0.94 | 0.03 | 0.00 | 0.03 | 4.5 | 1.5 | 5.4 |
| Comparative | 5.5 | 1 | 0 | 0 | 0 | 4.5 | 1.5 | 3.89 |
| Example 1 | | | | | | | | |
| Comparative | 5.5 | 0.94 | 0.06 | 0 | 0 | 4.5 | 1.5 | 4.26 |
| Example 2 | | | | | | | | |

Referring to Table 1 above, it can be seen that Example 1, where a portion of the P site is substituted with two substitute elements, has the best ionic conductivity.

Although the present disclosure has been described above by way of limited examples and drawings, the invention is not limited thereby, and various modifications and variations may be made by those having ordinary skill in the art, within the technical idea of the invention and the equivalent scope of the patent claims set forth below.

1. A sulfide-based solid electrolyte, containing lithium (Li), phosphorus (P), sulfur (S), chlorine (Cl) and M,
wherein M is included as a substitute for a part of the phosphorus (P) site and comprises at least two elements selected from the group consisting of Ge, Sn, Sb and Si.

2. The sulfide-based solid electrolyte according to claim 1,
wherein the sulfide-based solid electrolyte is represented by Formula 1 below: 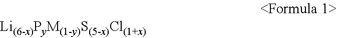
wherein x is 0<x<0.6, and y is 0<y≤0.9,
wherein M is M1ₐM2_{b} (wherein 0<a+b≤0.1, and a+b=1−y), M1ₐM2_{b}M3_{c} (wherein 0<a+b+c<0.1, and a+b+c=1−y) or M1ₐM2_{b}M3_{c}M4_{d} (wherein 0<a+b+c+d<0.1, and a+b+c+d=1−y),
wherein M1, M2, M3, and M4 are different elements selected from the group consisting of Ge, Si, Sb and Sn, respectively.

3. The sulfide-based solid electrolyte according to claim 1,
wherein the at least two elements substituted at the phosphorus (P) site are substituted in equal proportions, such that M is M1ₐM2_{b} (wherein 0<a+b<0.1, a+b=1−y, and a=b), M1ₐM2_{b}M3e (wherein 0<a+b+c<0.1, a+b+c=1−y, and a=b=c) or M1ₐM2_{b}M3_{c}M4_{d} (wherein 0<a+b+c+d<0.1, a+b+c+d=1−y, and a=b=c=d).

4. The sulfide-based solid electrolyte according to claim 1,
wherein the sulfide-based solid electrolyte has an argyrodite-type crystal structure.

5. The sulfide-based solid electrolyte according to claim 1,
wherein the sulfide-based solid electrolyte has an ionic conductivity of 4 to 6 mS/cm.

6. The sulfide-based solid electrolyte according to claim 1,
wherein an amount of an impurity in the sulfide-based solid electrolyte is 0% to 5% based on the intensity of the XRD main peak.

7. The sulfide-based solid electrolyte according to claim 6,
wherein the impurity comprises Li₂S, LiCl, or a compound thereof.

8. An all-solid-state battery comprising a positive electrode, a negative electrode, and a sulfide-based solid electrolyte interposed therebetween according to claim 1.

9. The all-solid-state battery according to claim 8, wherein the negative electrode is a lithium negative electrode comprising a lithium metal.
